(19) United States
(12) Patent Application Publication
(10) Pub. No.: US 2009/0005998 A1
(43) Pub. Date: Jan. 1, 2009

(54) MANUFACTURING APPARATUS AND DEVICE MANUFACTURING METHOD

(75) Inventor: Yosuke Orishimo, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/136,416

(22) Filed: Jun. 10, 2008

(30) Foreign Application Priority Data
Jun. 28, 2007 (JP) 2007-171226

(51) Int. Cl. G01V 1/00

(52) U.S. Cl. 702/15

(57) ABSTRACT

A manufacturing apparatus includes a receiver which receives earthquake information containing the time at which earthquake vibration is expected to arrive at the manufacturing apparatus or information to predict the time, an acquisition unit which acquires status information indicating the status of the manufacturing apparatus, a countermeasure determination unit which determines an earthquake countermeasure on the basis of the earthquake information and the status information, and a countermeasure execution unit which executes the earthquake countermeasure, which is determined by the countermeasure determination unit, before the earthquake vibration arrives at the manufacturing apparatus.

### BACKGROUND OF THE INVENTION

1. Field of the Invention

The present invention relates to a manufacturing apparatus which manufactures an article, and a device manufacturing method.

2. Description of the Related Art

An earthquake is a serious natural disaster for an exposure apparatus for manufacturing a device such as a semiconductor device, because it often damages an article such as a wafer or reticle. Under the circumstance, the exposure apparatus is required to take countermeasures against earthquakes.

As an earthquake countermeasure, Japanese Patent Laid-Open No. 6-204108 discloses a known method of performing emergency shutdown of the apparatus the moment that a vibrometer installed near the apparatus detects earthquake vibration. An inspector executes subsequent restoration in accordance with a manual.

Unfortunately, the method disclosed in Japanese Patent Laid-Open No. 6-204108 often takes much time to reactivate the apparatus after the earthquake vibration dies down, depending on the statuses of the apparatus and handled article upon the emergency shutdown. In addition, the article may be damaged and the apparatus may suffer faults because the apparatus had been running until the earthquake vibration is detected.

The method disclosed in Japanese Patent Laid-Open No. 6-204108 performs emergency shutdown of the apparatus even when the detected earthquake vibration is too small to adversely affect the manufacture. Subsequent restoration often takes much time, so the productivity may degrade contrary to the true intention purpose of the method.

### SUMMARY OF THE INVENTION

The present invention has been made in consideration of the above-described problems, and has as its exemplary object to reduce damage to a manufacturing apparatus due to earthquake vibration.

One aspect of the present invention relates to a manufacturing apparatus for manufacturing an article. The manufacturing apparatus includes a receiver which receives earthquake information containing the time at which earthquake vibration is expected to arrive at the manufacturing apparatus or information to predict the time, an acquisition unit which acquires status information indicating the status of the manufacturing apparatus, a countermeasure determination unit which determines an earthquake countermeasure on the basis of the earthquake information and the status information, and a countermeasure execution unit which executes the earthquake countermeasure, which is determined by the countermeasure determination unit, before the earthquake vibration arrives at the manufacturing apparatus.

According to the present invention, it is possible to reduce damage to a manufacturing apparatus due to, e.g., earthquake vibration.

Further features of the present invention will become apparent from the following description of exemplary embodiments with reference to the attached drawings.

### BRIEF DESCRIPTION OF THE DRAWINGS

FIG. 1 is a diagram schematically showing the system and environment surrounding an exposure apparatus according to a preferred embodiment of the present invention;

FIG. 2 is a block diagram showing the hardware configuration of the exposure apparatus according to the preferred embodiment of the present invention;

FIG. 3 is a block diagram illustrating functional blocks implemented by the hardware as shown in FIG. 2;

FIG. 4 is a flowchart for exemplifying the procedures of an earthquake countermeasure process and restoration process executed by the exposure apparatus;

FIG. 5 is a table showing an example of a list of earthquake countermeasure processes;

FIG. 6 is a table showing an example of a list of restoration processes;

FIG. 7 is a flowchart illustrating a detailed example of the process operation in step 403 of FIG. 4, i.e., a process operation for determining an earthquake countermeasure sequence;

FIG. 8 is a flowchart illustrating a detailed example of the process operation in step 407 of FIG. 4, i.e., a process operation for determining a restoration sequence; and

FIG. 9 is a flowchart illustrating the procedure of wafer retreat corresponding to countermeasure process No. 3 by an earthquake countermeasure execution unit 308.

### DESCRIPTION OF THE EMBODIMENT

A preferred embodiment of the present invention will be described below with reference to the accompanying drawings.

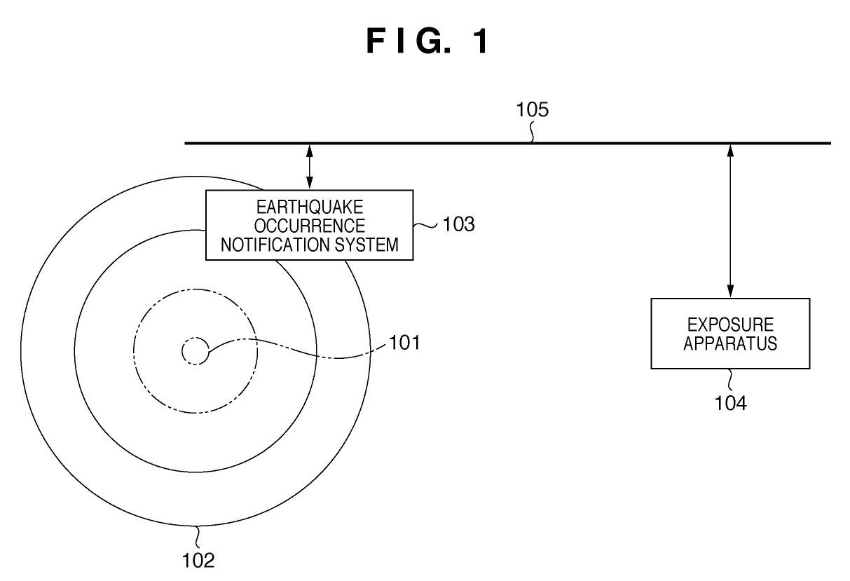

FIG. 1 is a diagram schematically showing the system and environment surrounding an exposure apparatus according to a preferred embodiment of the present invention. An earthquake wave (earthquake vibration) 102 which has occurred at an earthquake center 101 arrives at an exposure apparatus 104 as an example of a manufacturing apparatus for manufacturing an article via an earthquake occurrence notification system (seismic event notification system) 103.

The earthquake occurrence notification system 103 has a function of detecting the earthquake wave 102, a function of calculating, e.g., the time at which the detected earthquake wave 102 is expected to arrive at a predetermined place, and a function of transmitting information about, e.g., the calculated time to, e.g., other devices or facilities via a network 105.

The exposure apparatus 104 projects the pattern of a reticle (original) onto a wafer (substrate) via a projection optical system, thereby exposing the substrate. A latent pattern is thus formed on a photosensitive agent applied on the wafer. By developing this latent pattern, a mask pattern is formed.

The earthquake wave (earthquake vibration) 102 which has occurred at the earthquake center (seismic center) 101 propagates in a radial pattern from the earthquake center 101 with time. Upon detecting the earthquake wave 102, the earthquake occurrence notification system 103 notifies the exposure apparatus 104 as the manufacturing apparatus of earthquake information using the network 105. Since the signal transmitted via the network 105 propagates faster than the earthquake wave, the exposure apparatus 104 can receive the earthquake information and execute an earthquake countermeasure process before receiving the earthquake wave 102.

The earthquake information herein can contain, e.g., the time at which the earthquake wave 102 is expected to arrive at the exposure apparatus 104 as an example of the manufacturing apparatus, and the earthquake vibration intensity (e.g., the earthquake intensity) at the exposure apparatus 104. The earthquake information may contain information such as the earthquake occurrence time and the position of the earthquake center 101, which are necessary for the exposure apparatus 104 to predict the time at which the earthquake wave 102 is expected to arrive at the exposure apparatus 104, in place of or in addition to the time at which the earthquake wave 102 is expected to arrive at the exposure apparatus 104.

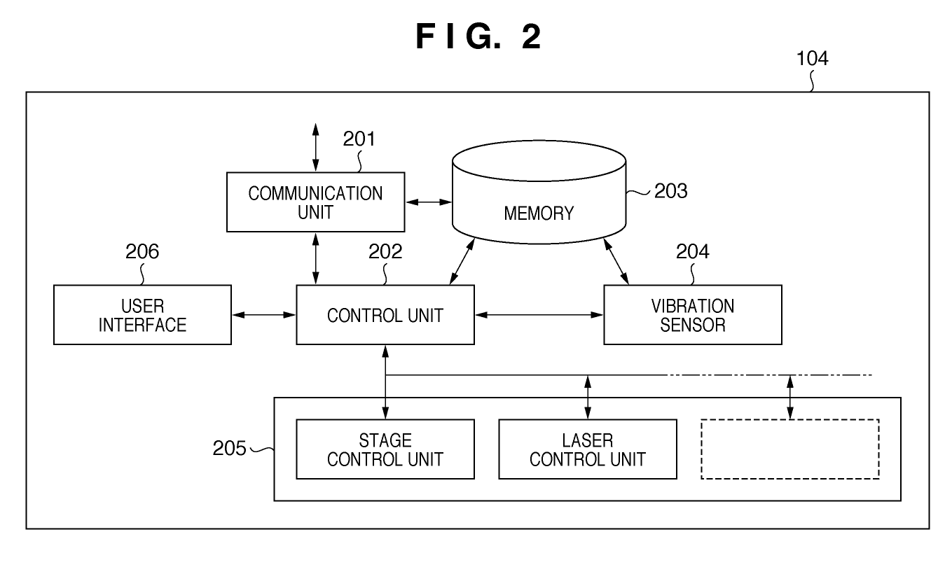

FIG. 2 is a block diagram showing the hardware configuration of the exposure apparatus 104 according to the preferred embodiment of the present invention. A communication unit 201 is connected to the network 105 and can communicate with other devices such as the earthquake occurrence notification system 103 via the network 105. The communication unit 201 is connected to a control unit 202 and memory 203 via, e.g., a bus. The exposure apparatus 104 receives the earthquake information from the earthquake occurrence notification system 103 via the communication unit 201, and transmits it to the control unit 202.

The control unit 202 is typically a computer which controls constituent devices of the exposure apparatus 104. The control unit 202 is connected to the communication unit 201, the memory 203, a vibration sensor 204, a hardware control unit 205, and a user interface 206 via, e.g., a bus.

The memory 203 is connected to, e.g., the communication unit 201, control unit 202, and vibration sensor 204 and can be accessed by these hardware devices. The vibration sensor 204 stores earthquake vibration received by the exposure apparatus 104 in the memory 203 as data.

The hardware control unit 205 controls various hardware devices such as a wafer stage, reticle stage, and laser (light source) in accordance with commands issued from the control unit 202. The hardware control unit 205 can include, e.g., stage control units for controlling the stages, and a laser control unit for controlling the laser.

The user interface 206 includes, e.g., a display unit and data input unit and provides, e.g., information indicating the status of the exposure apparatus 104 to the operator via the display unit. The user interface 206 can be used to allow the operator to issue a command to the exposure apparatus 104.

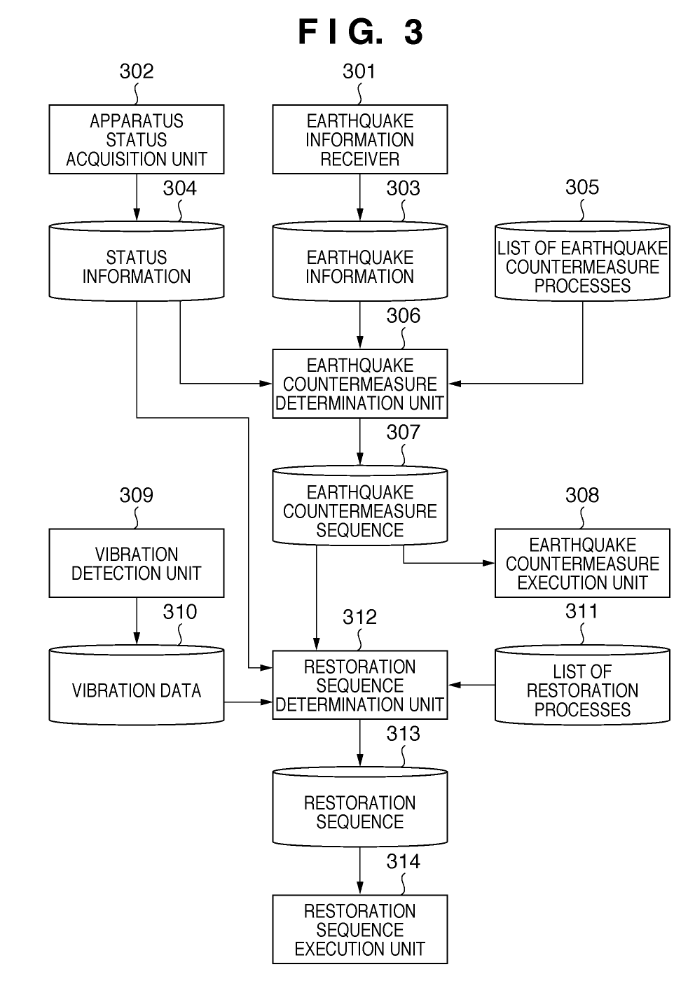

FIG. 3 is a block diagram illustrating functional blocks implemented by the hardware as shown in FIG. 2. An earthquake information receiver (receiver) 301 is implemented by, e.g., the communication unit 201 and receives earthquake information 303 sent from the earthquake occurrence notification system 103 via the network 105. The earthquake information receiver 301 stores the received earthquake information 303 in the memory 203. The earthquake information can contain, e.g., some or all of the time at which earthquake vibration is expected to arrive at an exposure apparatus, the earthquake vibration intensity at the position where the exposure apparatus is installed, the duration of the earthquake vibration, the direction of amplitude of the earthquake vibration, the arrival time of a P-wave, and the arrival time of an S-wave.

An apparatus status acquisition unit (acquisition unit) 302 is implemented by the control unit 202, monitors the status of the exposure apparatus 104, generates status information 304 indicating the status of the exposure apparatus 104, and stores it in the memory 203. The status information 304 can be updated in real time by the apparatus status acquisition unit 302. The status information can contain, e.g., the position information of a wafer (substrate) and reticle (original), and the position information of constituent hardware devices (e.g., a wafer stage, reticle stage, and convey module) of the exposure apparatus 104.

The memory 203 stores a list 305 of earthquake countermeasure processes. The earthquake countermeasure processes herein can include, e.g., an exposure process interruption process, a process for recovering water for use in immersion exposure, a wafer retreat process, and a reticle retreat process. Other earthquake countermeasure processes can be input to the exposure apparatus 104 via a user interface by the operator in advance.

An earthquake countermeasure determination unit (determination unit) 306 is implemented by the control unit 202 and determines an earthquake countermeasure on the basis of the earthquake information 303 and status information 304. The earthquake countermeasure determination unit 306 preferably determines an earthquake countermeasure which can be completed before the time at which earthquake vibration is expected to arrive at the exposure apparatus 104. For example, the earthquake countermeasure determination unit (determination unit) 306 selects at least one earthquake countermeasure process which can be completed before the time at which earthquake vibration is expected to arrive at the exposure apparatus 104 from the list 305 of earthquake countermeasure processes. The earthquake countermeasure determination unit (determination unit) 306 determines an earthquake countermeasure sequence 307 including the at least one selected earthquake countermeasure process. The determined earthquake countermeasure sequence is stored in the memory 203.

An earthquake countermeasure execution unit 308 executes the earthquake countermeasure sequence 307 under the control of the control unit 202.

A vibration detection unit 309 is implemented by the vibration sensor 204, detects vibration of the exposure apparatus 104, and stores the detection result in the memory 203 as vibration data 310.

The memory 203 stores a list 311 of restoration processes for restoring, after earthquake vibration dies down, the exposure apparatus 104 to the status before the earthquake countermeasure sequence is executed. The restoration processes herein can include, e.g., a process for restoring a reticle to the status before it is retreated, a process for restoring a wafer to the status before it is retreated, a process for replenishing water for use in immersion exposure, and a process for restarting an exposure process. The restoration processes can also include, e.g., a process for correcting the exposure apparatus, and a process for checking damage to articles such as a wafer and reticle. The restoration processes can be input to the exposure apparatus 104 via a user interface by the operator in advance.

A restoration sequence determination unit 312 is implemented by the control unit 202. The restoration sequence determination unit 312 determines a restoration sequence on the basis of the status information 304, the vibration data 310, the earthquake countermeasure sequence 307, and the list 311 of restoration processes. More specifically, the restoration sequence determination unit 312 selects at least one restoration process from the list 311 of restoration processes, determines a restoration sequence 313 including the at least one selected restoration process, and stores it in the memory 203.

A restoration sequence execution unit 314 is implemented by the control unit 202 and executes the restoration sequence 313 after earthquake vibration dies down.

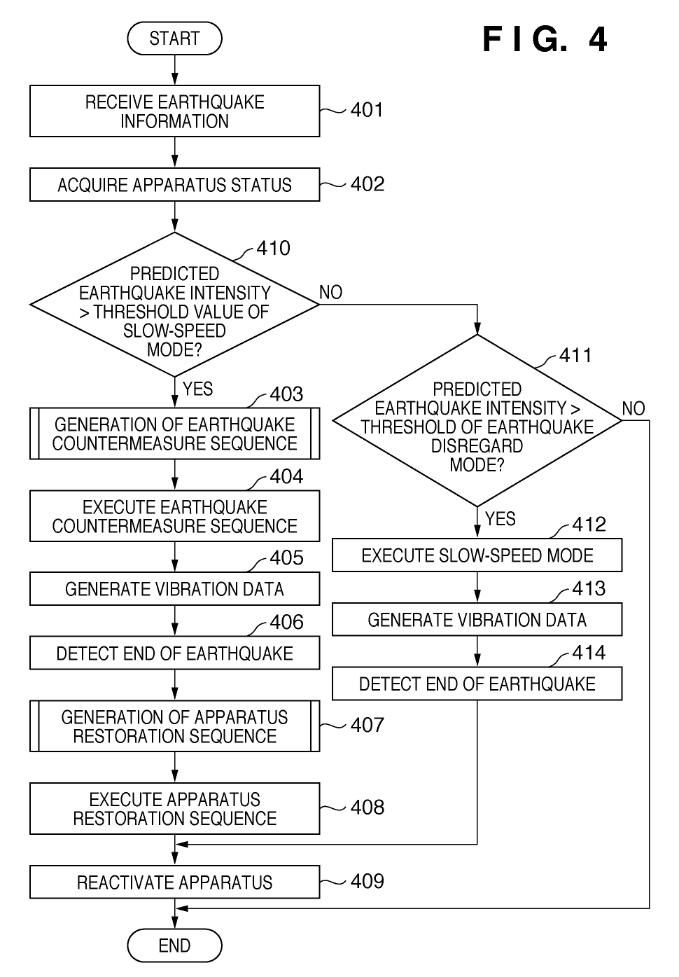

FIG. 4 is a flowchart for exemplifying the procedures of the earthquake countermeasure process and restoration process executed by the exposure apparatus 104.

In step 401, the earthquake information receiver 301 receives the earthquake information 303 from the earthquake occurrence notification system 103, and stores it in the memory 203. In step 402, the apparatus status acquisition unit 302 acquires the status information 304 of the exposure apparatus.

In step 410, the control unit 202 compares the earthquake vibration intensity contained in the earthquake information 303 with a preset threshold value (reference value) of a slow-speed mode. If the intensity is higher than the threshold value, the control unit 202 advances the process to step 403. If the intensity is equal to or lower than the threshold value, the control unit 202 advances the process to step 411. The threshold value of the slow-speed mode herein means an earthquake vibration intensity serving as a criterion according to which the earthquake countermeasure determination unit 306 can determine whether to execute the earthquake countermeasure sequence or slow-speed mode. Executing the slow-speed mode without executing the earthquake countermeasure sequence makes it possible to suppress a decrease in the productivity of the exposure apparatus due to an earthquake that is too small to adversely affect the manufacture. The threshold value of the slow-speed mode can be input to the exposure apparatus 104 via a user interface by the operator in advance.

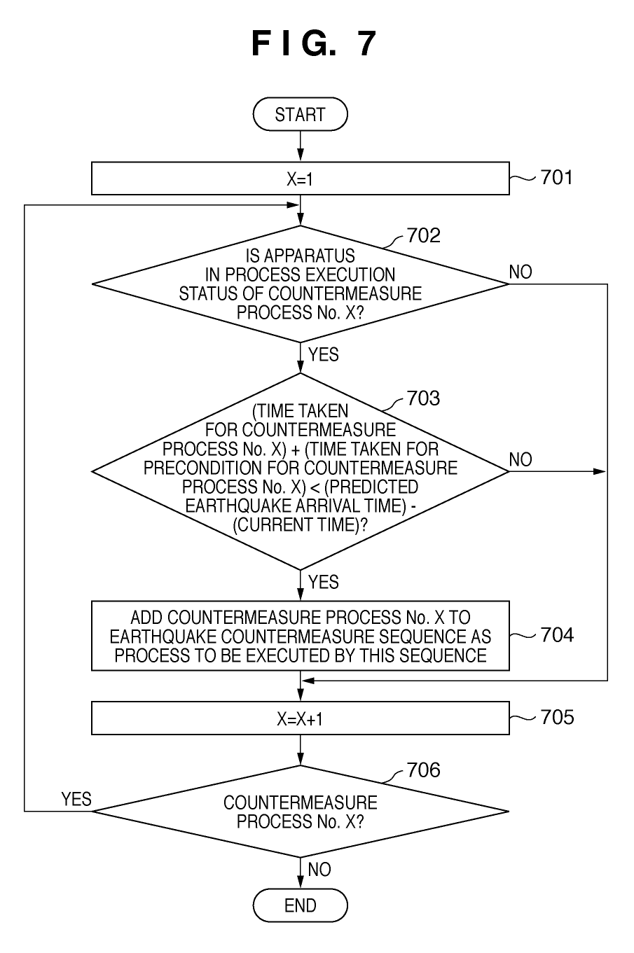

In step 403, on the basis of the earthquake information 303 and status information 304, the earthquake countermeasure determination unit 306 determines the earthquake countermeasure sequence 307 by looking up the list 305 of earthquake countermeasure processes. The earthquake countermeasure determination unit 306 stores the earthquake countermeasure sequence 307 in the memory 203. Details of the process operation in step 403 will be explained later with reference to FIG. 7.

In step 404, the earthquake countermeasure execution unit 308 executes the earthquake countermeasure sequence 307. In step 405, the vibration detection unit 309 starts a process for generating the vibration data 310 during the period from when the earthquake wave (earthquake vibration) 102 arrives at the exposure apparatus 104 until the earthquake wave 102 dies down. The vibration data 310 is stored in the memory 203. In step 406, the restoration sequence determination unit 312 detects the end of the earthquake on the basis of the vibration data 310.

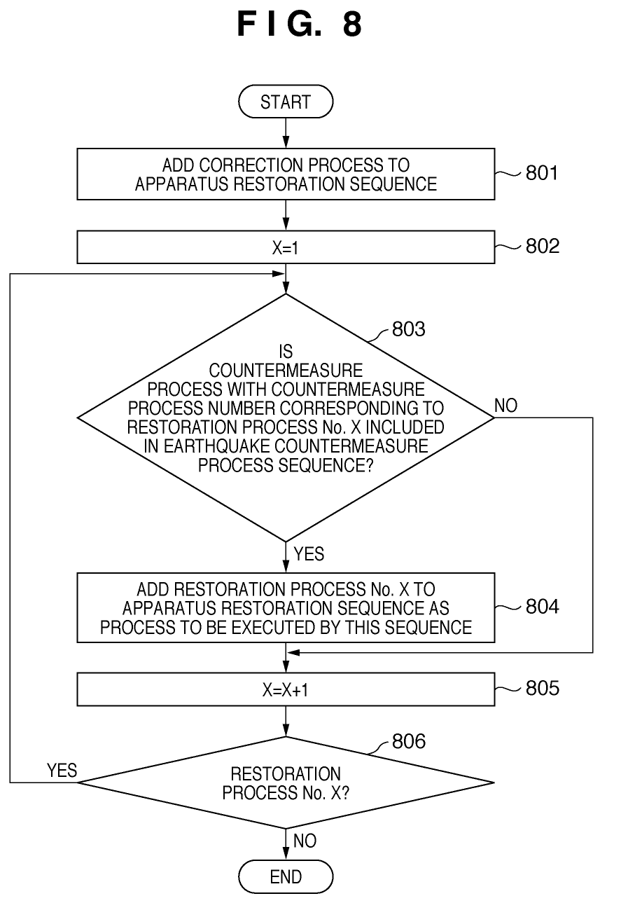

In step 407, on the basis of the vibration data 310 and earthquake countermeasure sequence 307, the restoration sequence determination unit 312 generates the restoration sequence 313 by looking up the list 311 of restoration processes, and stores it in the memory 203. Details of the process operation in step 407 will be explained later with reference to FIG. 8.

In step 408, the restoration sequence execution unit 314 executes the restoration sequence 313. After the restoration sequence execution unit 314 completes the restoration sequence 313, an exposure process is restarted in step 409.

In step 411, the earthquake countermeasure determination unit 306 compares the earthquake vibration intensity contained in the earthquake information 303 with the threshold value of an earthquake disregard mode. If the intensity is higher than the threshold value, the process advances to step 412. If the intensity is equal to or lower than the threshold value, the process ends.

The threshold value of the earthquake disregard mode is an earthquake vibration intensity serving as a criterion according to which the earthquake countermeasure determination unit 306 can determine whether to execute the slow-speed mode or continue an exposure process in progress by disregarding an earthquake. If the intensity is higher than the threshold value, the slow-speed mode is executed. If the intensity is equal to or lower than the threshold value, a process in progress by the exposure apparatus is continued. This process can suppress a decrease in the productivity of the exposure apparatus due to an earthquake that is too small to adversely affect the manufacture. The threshold value of the earthquake disregard mode can be input to the exposure apparatus 104 via a user interface by the operator in advance.

In step 412, the earthquake countermeasure execution unit 308 executes the slow-speed mode. In step 413, the vibration detection unit 309 starts a process for generating the vibration data 310 during the period from when the earthquake wave (earthquake vibration) 102 arrives at the exposure apparatus 104 until the earthquake wave 102 dies down, and storing it in the memory 203.

In step 414, the restoration sequence determination unit 312 detects the end of the earthquake on the basis of the vibration data 310, and advances the process to step 409.

In the above-described steps, using the user interface 206, the control unit 202 can display, e.g., earthquake information, the status of the exposure apparatus, earthquake countermeasures, earthquake countermeasure sequences, vibration data, the detection of the end of an earthquake, and apparatus restoration sequences. This display may be done in accordance with, e.g., a request from the operator or on the basis of, e.g., the reception of earthquake information.

For example, the operator may select a desired sequence depending on the situation from some earthquake countermeasure sequences or some restoration sequences displayed on the user interface under the control of the control unit 202.

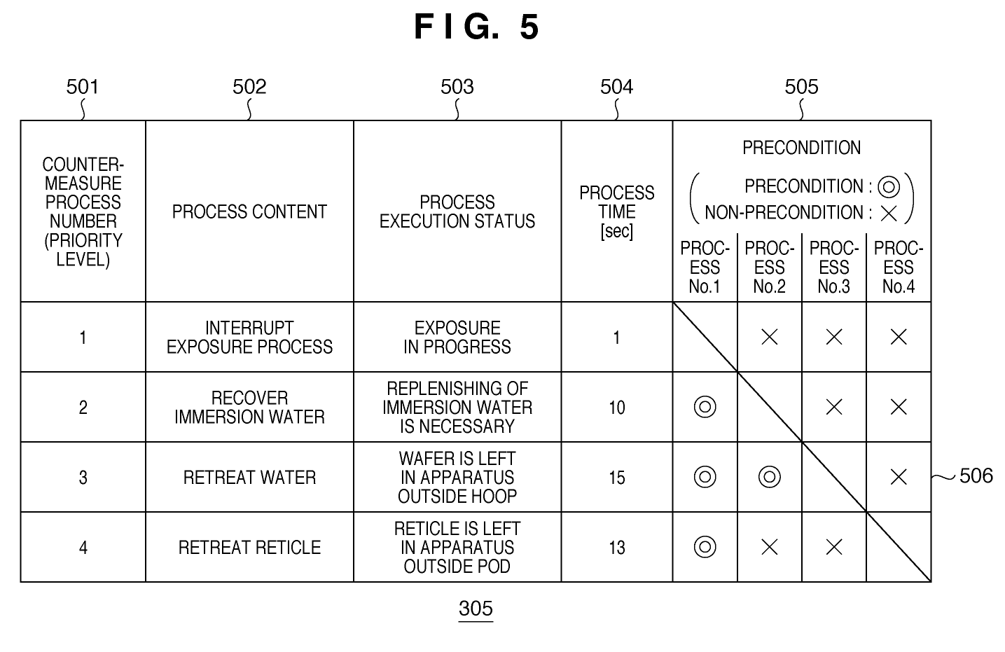

FIG. 5 shows an example of the list 305 of earthquake countermeasure processes. The list 305 of earthquake countermeasure processes includes a plurality of earthquake countermeasure processes, and each row describes one process in the example shown in FIG. 5.

A column 501 describes the countermeasure process number as the serial number and priority level of each earthquake countermeasure process by the exposure apparatus. A column 502 describes the process content executed by the control unit 202 as an earthquake countermeasure. A column 503 describes the process execution status of the exposure apparatus, which serves as a condition under which the exposure apparatus needs to execute each earthquake countermeasure process. A column 504 describes the process time taken to execute each earthquake countermeasure process.

A column 505 is the precondition to execute the earthquake countermeasure process in each row. A double circle mark represents an earthquake countermeasure process which can be executed when a corresponding earthquake countermeasure process is not executed, or an earthquake countermeasure process which can be executed after a corresponding earthquake process is completed. A cross mark represents an earthquake countermeasure process which can always be executed independently of the execution state of a corresponding earthquake countermeasure process.

For example, a row 506 describes a wafer retreat process as earthquake countermeasure process No. 3. This process can be executed as the earthquake countermeasure determination unit 306 is activated while a wafer is left in the exposure apparatus outside a hoop. As described as the process time in the column 504, the time taken for this process is 15 sec. As described as the precondition in the column 505, the condition to start this process is that countermeasure process No. 1 is not executed or that countermeasure process No. 1 is complete. Likewise, another condition to start this process is that countermeasure process No. 2 is not executed or that countermeasure process No. 2 is complete. The wafer retreat process as earthquake countermeasure process No. 3 can be executed independently of the execution state of countermeasure process No. 4.

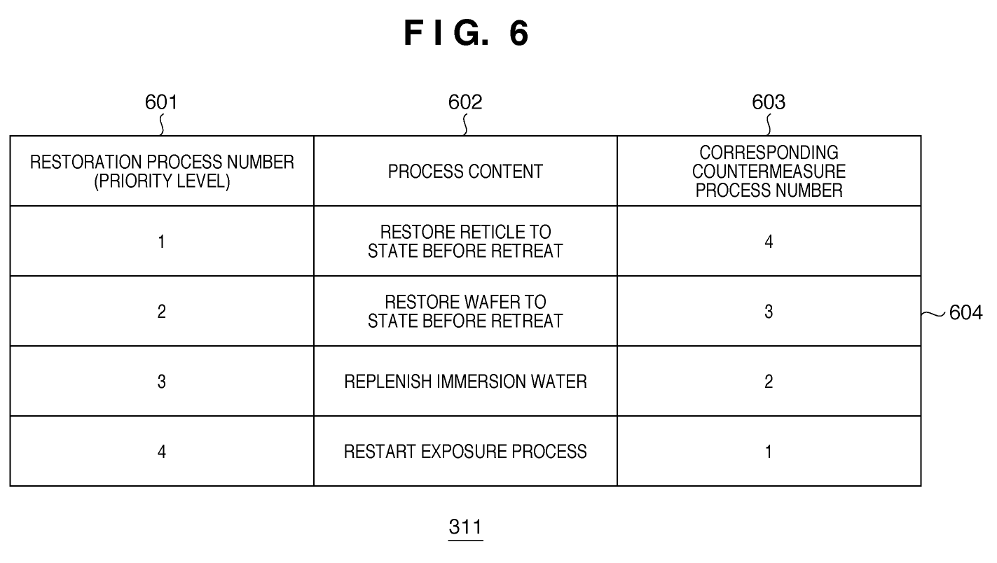

FIG. 6 shows an example of the list 311 of restoration processes. The list 311 of restoration processes includes a plurality of restoration processes. A column 601 describes the restoration process number as the serial number and priority level of each restoration process. A column 602 describes the restoration process content. A column 603 describes the corresponding countermeasure process number, which indicates a relationship with the countermeasure process number shown in FIG. 5.

For example, a row 604 describes restoration process No. 2. Restoration process No. 2 is a process for restoring a wafer to the status before it is retreated. The corresponding countermeasure process number of restoration process No. 2 is 3. Accordingly, restoration process No. 2 is executed by the restoration sequence execution unit 314 after the earthquake countermeasure execution unit 308 executes countermeasure process No. 3 shown in FIG. 5.

FIG. 7 is a flowchart illustrating a detailed example of the process operation in step 403 of FIG. 4, i.e., a process operation for determining an earthquake countermeasure sequence. In step 701, a variable X is set to “1”. In step 702, it is determined on the basis of the status information 304 of the exposure apparatus whether the exposure apparatus is in the process execution status described for countermeasure process No. X of the list 305 of earthquake countermeasure processes. If YES in step 702, the process advances to step 703. If NO in step 702, the process advances to step 705.

In step 703, it is determined whether the total of the process time described for countermeasure process No. X and that taken for a countermeasure process marked by a double circle as the precondition for countermeasure process No. X is shorter than the difference (remaining time) between the predicted earthquake arrival time and the current time. If it is determined that the total process time is shorter than the remaining time, the process advances to step 704; otherwise, the process advances to step 705. The predicted earthquake arrival time is the time at which earthquake vibration is expected to arrive at the exposure apparatus, and is contained in the earthquake information or can be predicted from the earthquake information.

In step 704, countermeasure process No. X is added to the earthquake countermeasure sequence as one countermeasure process to be executed. In step 705, the X value is incremented by one. In step 706, it is determined whether countermeasure process No. X is present. If YES in step 706, the process returns to step 702. If NO in step 706, the process ends.

FIG. 8 is a flowchart illustrating a detailed example of the process operation in step 407 of FIG. 4, i.e., a process operation for determining a restoration sequence. In step 801, a process for correcting the exposure apparatus corresponding to earthquake vibration received by the exposure apparatus is added to the restoration sequence on the basis of the vibration data 310.

In step 802, a variable X is set to “1”. In step 803, it is determined whether a countermeasure process with a countermeasure process number corresponding to restoration process No. X is included in an executed earthquake countermeasure sequence. If YES in step 803, the process advances to step 804. If NO in step 803, the process advances to step 805.

In step 804, restoration process No. X is added to the restoration sequence as one restoration process to be executed. In step 805, the X value is incremented by one. In step 806, it is determined whether restoration process No. X is present. If YES in step 806, the process returns to step 803. If NO in step 806, the process ends.

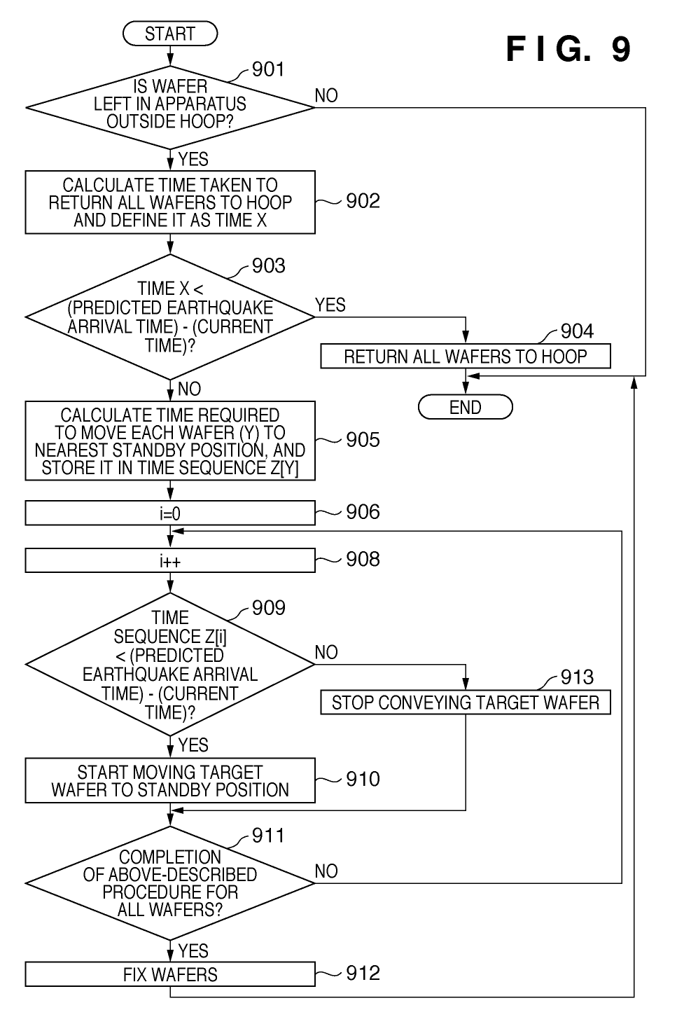

FIG. 9 is a flowchart illustrating the procedure of wafer retreat corresponding to countermeasure process No. 3 by the earthquake countermeasure execution unit 308. In step 901, the earthquake countermeasure execution unit 308 determines on the basis of the status information 304 of the exposure apparatus whether any wafer is left in the exposure apparatus outside a hoop. If YES in step 901, the process advances to step 902. If NO in step 901, the process ends. The hoop herein means a case which can accommodate several wafers as one set. A wafer receives a smaller shock from earthquake vibration when it is accommodated in the hoop than when it is left in the exposure apparatus outside the hoop. In addition, even when a wafer accommodated in the hoop breaks, its fragments never scatter into the exposure apparatus. Hence, accommodating wafers in the hoop is suitable as an earthquake countermeasure.

In step 902, the time taken to return all the wafers to the hoop is calculated and defined as a time X. In step 903, it is determined whether the time X is shorter than the difference (remaining time) between the predicted earthquake arrival time and the current time. If the time X is shorter than the remaining time, the process advances to step 904. If the time X is equal to or longer than the time X, the process advances to step 905.

In step 904, all the wafers are returned to the hoop, and the process ends.

In step 905, the time required to move each wafer (Y) to a nearest standby position is calculated, and the calculation result is stored in a time sequence Z[Y] (Y is one origin). The wafer position in the exposure apparatus can be, e.g., a wafer stage on which an exposure process is executed, a convey module which conveys a wafer, or a standby position where a wafer is temporarily set. A wafer is generally more resistant to earthquake vibration at the standby position than on the convey module.

“0” is substituted for a variable i in step 906, and the variable i is incremented by one in step 908.

In step 909, it is determined whether the value stored in the time sequence Z[i], i.e., the time required to move the ith wafer to the standby position is shorter than the difference (remaining time) between the predicted earthquake arrival time and the current time. If the required time is shorter than the remaining time, the process advances to step 910; otherwise, the process advances to step 913.

In step 910, the earthquake countermeasure execution unit 308 starts moving the ith wafer to the standby position.

In step 911, it is determined whether the above-described procedure is complete for all the wafers left in the exposure apparatus. If NO in step 911, the process returns to step 908.

In step 912, all the wafers in the exposure apparatus which have been moved to the retreat positions are fixed. This fixing can be done by, e.g., vacuum chucking or electrostatic attraction.

In step 913, the conveyance of the ith wafer is stopped.

Although the order of priority as the wafer retreat destination is the hoop, standby position, and convey module herein, it is not particularly limited to this because an effective standby position depends on the apparatus structure and user's need. Furthermore, although wafer retreat has been exemplified herein, a reticle can be retreated in accordance with the same procedure.

A device manufacturing method using the above-described exposure apparatus will be explained next. A device manufacturing method according to a preferred embodiment of the present invention is suitable to manufacture, e.g., a semiconductor device and liquid crystal device. This method can include steps of transferring the pattern of an original onto a photosensitive agent applied on a substrate using the above-described exposure apparatus, and developing the photosensitive agent.

According to a preferred embodiment of the present invention, it is possible to reduce damage to a manufacturing apparatus due to earthquake vibration by taking earthquake countermeasures on the basis of earthquake information before the earthquake vibration arrives at the manufacturing apparatus. In addition, the manufacturing apparatus can wait until the earthquake dies down in a relatively stable status by taking the earthquake countermeasures. This makes it possible to shorten the restoration time until the manufacturing apparatus is reactivated after the earthquake dies down.

When an earthquake that is too small to adversely affect the manufacture is detected, the manufacturing apparatus is switched to a slow-speed mode of slowing down the process speed or allowed to continue normal operation instead of stopping the manufacturing apparatus. This makes it possible to suppress a decrease in the productivity of the manufacturing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-171226, filed Jun. 28, 2007, which is hereby incorporated by reference herein in its entirety.

What is claimed is:

1. A manufacturing apparatus for manufacturing an article, comprising:
a receiver configured to receive earthquake information containing one of a time at which earthquake vibration is expected to arrive at said manufacturing apparatus and information to predict the time;
an acquisition unit configured to acquire status information indicating a status of said manufacturing apparatus;
a countermeasure determination unit configured to determine an earthquake countermeasure on the basis of the earthquake information and the status information; and
a countermeasure execution unit configured to execute the earthquake countermeasure, which is determined by said countermeasure determination unit, before the earthquake vibration arrives at said manufacturing apparatus.

2. The apparatus according to claim 1, wherein said countermeasure determination unit determines an earthquake countermeasure which can be completed before the time at which the earthquake vibration is expected to arrive at said manufacturing apparatus.

3. The apparatus according to claim 2, wherein said countermeasure determination unit selects at least one earthquake countermeasure process which can be completed before the time at which the earthquake vibration is expected to arrive at said manufacturing apparatus from a list of earthquake countermeasure processes, and determines an earthquake countermeasure sequence including the at least one selected earthquake countermeasure process, and said countermeasure execution unit executes the earthquake countermeasure sequence.

4. The apparatus according to claim 1, further comprising a restoration sequence execution unit configured to restore, after the earthquake vibration dies down, said manufacturing apparatus to a status before the earthquake countermeasure is executed.

5. The apparatus according to claim 1, wherein the earthquake information contains information associated with an earthquake vibration intensity, and said countermeasure determination unit determines an earthquake countermeasure in accordance with the earthquake vibration intensity.

6. The apparatus according to claim 1, wherein said manufacturing apparatus includes an exposure apparatus configured to project a pattern of an original onto a substrate, thereby exposing the substrate.

7. The apparatus according to claim 6, wherein the earthquake countermeasure includes a process for retreating at least one of the original and the substrate.

8. A manufacturing apparatus for manufacturing an article, comprising:
a receiver configured to receive earthquake information from an earthquake occurrence notification system;
an acquisition unit configured to acquire status information indicating a status of said manufacturing apparatus;
a countermeasure determination unit configured to determine an earthquake countermeasure on the basis of the earthquake information and the status information; and
a countermeasure execution unit configured to execute the earthquake countermeasure, which is determined by said countermeasure determination unit, before the earthquake vibration arrives at said manufacturing apparatus.

9. A device manufacturing method, comprising the steps of:
exposing a substrate using a manufacturing apparatus defined in claim 6; and
developing the substrate.
